(19) United States
(12) Patent Application Publication
(10) Pub. No.: US 2026/0137577 A1
(43) Pub. Date: May 21, 2026

(54) DEVICES AND METHODS OF GLUTEAL MANIPULATION AND ENHANCEMENT

(71) Applicant: Abdulmuta-ali Muhammad, Stonecrest, GA (US)

(72) Inventor: Abdulmuta-ali Muhammad, Stonecrest, GA (US)

(21) Appl. No.: 19/389,105

(22) Filed: Nov. 14, 2025

Related U.S. Application Data
(60) Provisional application No. 63/721,765, filed on Nov. 18, 2024.
(60) Provisional application No. 63/848,466, filed on Jul. 22, 2025.

(51) Int. Cl. A61H 1/02; A63B 23/035

(52) U.S. Cl. CPC A61H 1/02; A63B 23/03575; A61H 2205/086; A61H 2205/088

(57) ABSTRACT

Gluteal manipulation devices and methods are provided comprising a flexible harness configured to be worn by a user and a tensionable pulling element. The flexible harness defines at least one channel and includes a rear portion configured to wrap around the user's waist and two downward extension portions configured to sit adjacent to the groin of the user. The tensionable pulling element has two ends and runs through the channel so the two ends extend from the two downward extension portions. In exemplary embodiments, the channel is a guide channel running along the flexible harness, and the tensionable pulling element sits in the guide channel. When the two ends of the tensionable pulling element are pulled by the user or by an actuator, the flexible harness moves the gluteal muscles of the user.

### CROSS-REFERENCE TO RELATED APPLICATIONS

This application is a non-provisional of and claims priority to U.S. Patent Application No. 63/848,466, filed Jul. 22, 2025, and U.S. Patent Application No. 63/721,765, filed Nov. 18, 2024, each of which is hereby incorporated by reference in its entirety.

### FIELD OF THE DISCLOSURE

The present disclosure relates to gluteal manipulation devices and methods. The present disclosure relates to wearable devices for muscle manipulation, particularly a harness system designed to facilitate movement and control of the gluteal muscles for exercise, entertainment, or therapeutic purposes.

### BACKGROUND

Conventional wearable products targeting gluteal stimulation or enhancement often involve belts, straps, or rigid structures. These typically rely on manual contact with the gluteal muscles or powered mechanical linkages that restrict mobility or encase the lower body in cumbersome ways.

There is a need for a lightweight, compliant mechanism that enables gluteal engagement through rhythmic or resistive pulling action, with anatomical targeting and broad comfort, and that reliably retains the pulling element in position.

### SUMMARY

The present disclosure, in its many embodiments, alleviates to a great extent the disadvantages of known products for gluteal stimulation or enhancement by providing a harness system designed to allow users to manipulate their gluteal muscles without direct contact, i.e., without directly touching the glutes. Exemplary embodiments are wearable, compliant-body devices that allow hands-off manipulation and enhancement of gluteal motion. A compliant device or mechanism refers to a structure that achieves motion through material flexibility or elasticity, rather than through hinged, pinned, or articulated joints. Exemplary embodiments employ a flexible harness and silk rope configuration. A motorized version enables hands-free operation with programmable and remote-control capabilities for gluteal muscle movement.

The device is adaptable for various uses, including fitness, exercise, fascia therapy, dance, sexual wellness, shapewear, fashion, and motorized applications. More particularly, exemplary devices have multiple applications, including but not limited to, facilitating dance movements such as twerking or glute clapping, serving as exercise equipment for glute and arm workouts, acting as shapewear or therapeutic massagers, and enhancing entertainment experiences through motorized functionalities.

Exemplary embodiments of a gluteal manipulation device comprise a flexible harness configured to be worn by a user and a tensionable pulling element having two ends. The flexible harness defines at least one channel and includes a rear portion configured to wrap around the user's waist and two downward extension portions configured to sit adjacent to the groin of the user. The tensionable pulling element at least partially runs through the channel so the two ends extend from the two downward extension portions. The tensionable pulling element may be a rope or a flexible tube.

In exemplary embodiments, the user pulls the two ends of the tensionable pulling element forward or upward. The device could further comprise at least one actuator incorporated into the device, and the actuator pulls the two ends of the tensionable pulling element. When the two ends of the tensionable pulling element are pulled, the flexible harness moves the gluteal muscles of the user. The flexible harness returns to a relaxed shape when the user releases tension on the tensionable pulling element.

In exemplary embodiments, the channel comprises a plurality of channels, and the tensionable pulling element is threaded through the plurality of channels. The channel could be a guide channel running along the flexible harness, and the tensionable pulling element sits in the guide channel. In exemplary embodiments, the guide channel has a dual corkscrew geometry. Alternatively, the guide channel could have an S-shaped or spiral geometry. There may be retention lips running along the guide channel, and the tensionable pulling element is maintained in the guide channel by the retention lips. Other configurations and embodiments may include different channel geometries, multiple tensionable pulling elements, and/or hybrid materials.

In exemplary embodiments, the flexible harness provides anatomical engagement, wrapping around the waist of the user and staying in place without fully closing around the waist of the user and without any fasteners. In exemplary embodiments, the rear portion of the flexible harness wraps around the user's lower back or waist and the two downward extension portions terminate at or near where the gluteal muscles and hamstring muscle overlap. The gluteal manipulation device may have a tensile strength of about 500 pounds per square inch.

An exemplary embodiment of a gluteal manipulation device comprises a flexible harness configured to be worn by a user. The flexible harness includes a rear portion configured to wrap around the user's waist and two downward extension portions configured to sit adjacent to the groin of the user. When the ends of the two downward extension portions of the flexible harness are pulled forward or upward, the flexible harness moves the gluteal muscles of the user.

Exemplary methods of manipulating gluteal muscles comprise the steps of wrapping a rear portion of a flexible harness around the back of the waist, routing two downward extension portions under the groin, and applying tension to a tensionable pulling element. The tensionable pulling element runs through at least one channel defined in the flexible harness. The tension application step comprises pulling two ends of the tensionable pulling element forward or upward, which causes the flexible harness to move the gluteal muscles.

In exemplary embodiments, the tension application step comprises activating an actuator. Exemplary embodiments further comprise releasing the tension on the tensionable pulling element to cause the flexible harness to return to a relaxed shape and may further comprise re-tensioning the tensionable pulling element to cause the flexible harness to oscillate the gluteal muscles. Applying tension, releasing, and re-tensioning the tensionable pulling element could be performed while the user is dancing or exercising or during intimate activity.

Accordingly, it is seen that devices and methods of gluteal manipulation are provided. These and other features and advantages will be appreciated from review of the following detailed description, along with the accompanying figures in which like reference numbers refer to like parts throughout.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a front perspective view of an exemplary embodiment of a gluteal manipulation device in accordance with the present disclosure;

FIG. 2 is a rear perspective view of the gluteal manipulation device of FIG. 1;

FIG. 3A is a perspective view of the gluteal manipulation device of FIG. 1 showing spaced-apart channels and a clip;

FIG. 3B is a detail view of the gluteal manipulation device of FIG. 1 showing spaced-apart channels and a clip;

FIG. 4 is a front perspective view of an exemplary embodiment of a gluteal manipulation device in accordance with the present disclosure;

FIG. 5 is a southwest isometric view of the gluteal manipulation device of FIG. 4;

FIG. 6 is a rear perspective view of an exemplary embodiment of a gluteal manipulation device in accordance with the present disclosure;

FIG. 7 is a top elevation view of the gluteal manipulation device of FIG. 6;

FIG. 8A is a front perspective view of the gluteal manipulation device of FIG. 6 illustrating channel geometries;

FIG. 8B is a cross-sectional view of the gluteal manipulation device of FIG. 6 illustrating channel geometries;

FIG. 8C is a cross-sectional view of the gluteal manipulation device of FIG. 6 illustrating channel geometries;

FIG. 9 is a left-side elevation view of the gluteal manipulation device of FIG. 6;

FIG. 10 is a right-side elevation view of the gluteal manipulation device of FIG. 6;

FIG. 11 is a left-side detail view of the gluteal manipulation device of FIG. 6 illustrating an exemplary tensionable pulling element in accordance with the present disclosure;

FIG. 12A is a front view of an exemplary embodiment of a gluteal manipulation device in accordance with the present disclosure worn by a user;

FIG. 12B is a rear view of an exemplary embodiment of a gluteal manipulation device in accordance with the present disclosure worn by a user;

FIG. 12C is a side view of an exemplary embodiment of a gluteal manipulation device in accordance with the present disclosure worn by a user;

FIG. 13A is a side view of an exemplary embodiment of a gluteal manipulation device in accordance with the present disclosure worn by a user;

FIG. 13B is perspective view of an exemplary embodiment of a hand-worn actuator in accordance with the present disclosure.

FIG. 14 is a rear perspective view of an exemplary embodiment of a gluteal manipulation device in accordance with the present disclosure showing sensor locations;

FIGS. 14A-14N are front, rear, and side views illustrating a process of a user putting on an exemplary embodiment of a gluteal manipulation device in accordance with the present disclosure

FIG. 15A is a rear view of an exemplary embodiment of a gluteal manipulation device in use;

FIG. 15B is a side view of an exemplary embodiment of a gluteal manipulation device in use;

FIGS. 16A-16D are rear views of an exemplary embodiment of a gluteal manipulation device in use; and

FIG. 17 is a detail view illustrating a user moving an exemplary tensionable pulling element to tension an exemplary embodiment of a gluteal manipulation device.

### DETAILED DESCRIPTION

In the following detailed description of exemplary embodiments of the disclosure, reference is made to the accompanying drawings in which like references indicate similar elements, and in which is shown by way of illustration specific embodiments in which disclosed devices, systems, and methods may be practiced. These embodiments are described in sufficient detail to enable those skilled in the art to practice the embodiments, and it is to be understood that other embodiments may be utilized, and that logical, mechanical, functional, and other changes may be made without departing from the scope of the present disclosure. The following detailed description is, therefore, not to be taken in a limiting sense, and the scope of the present disclosure is defined by the appended claims. As used in the present disclosure, the term “or” shall be understood to be defined as a logical disjunction and shall not indicate an exclusive disjunction.

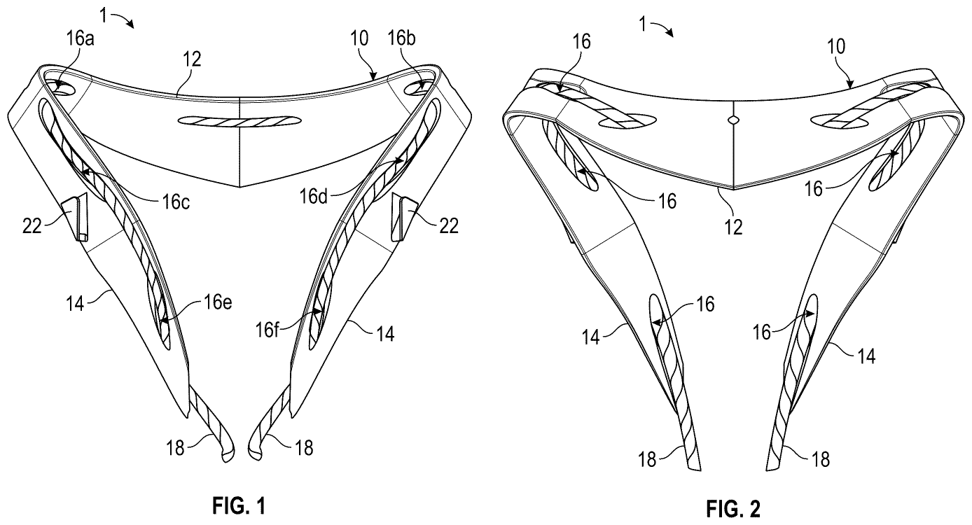

Referring to FIGS. 1 and 2, an exemplary embodiment of a gluteal manipulation device 1 comprises a single-body flexible harness 10 designed to be worn by a human user and a tensionable pulling element 18 that engages with the harness. The flexible harness 10 has a rear portion 12 configured to wrap around the user's waist or lower back and two downward extension portions 14 that extend toward the user's groin to anchor the structure.

The flexible harness 10 defines a plurality of spaced apart channels 16. In exemplary embodiments, the rear portion 12 of the harness 10 has two channels 16a, 16b, and a second pair of channels 16c, 16d are defined in opposite sides of the harness 10 closer to the downward extension portions 14. The downward extension portions 14 have two channels 16e, 16f on either side. As discussed in more detail herein, the tensionable pulling element 18 is threaded through the channels 16.

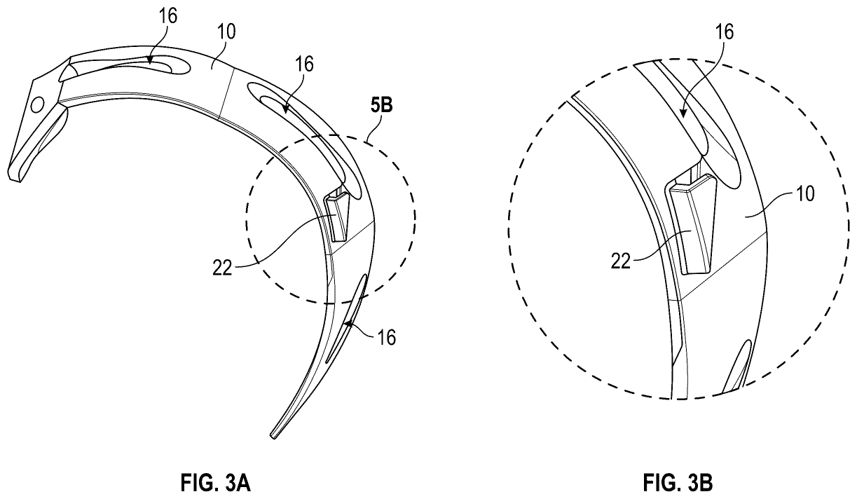

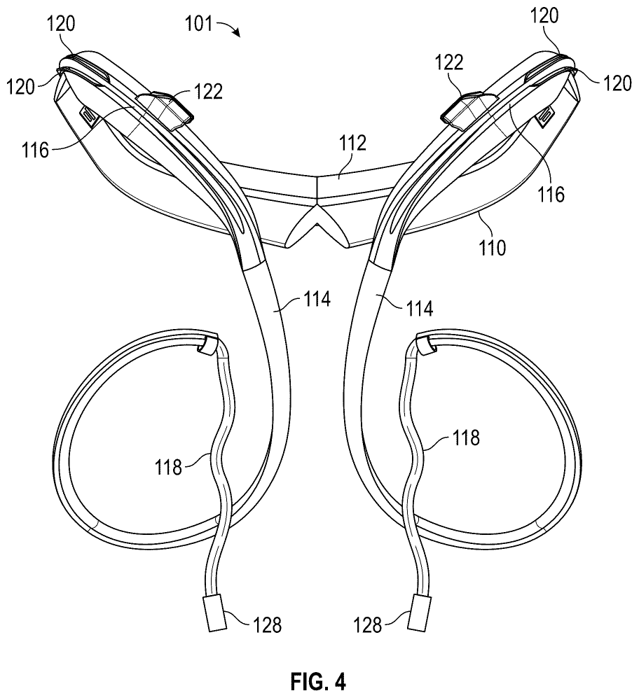

Together with channels 16, the flexible harness 10 may have connected or integrally formed clips 22 to keep the tensionable pulling element 18 in place when the device 1 is not in use. In exemplary embodiments, there is a clip 22 located on each side of the flexible harness 10 toward the front near where the user's hip bones would be when wearing the device 1. FIGS. 3A and 3B best illustrate clip 22. The clips 22 are made of the same silicone or plastic material as the harness 10 and are about 25-35 mm wide, about 12-20 mm tall and protrude about 8-14 mm out from the harness 10.

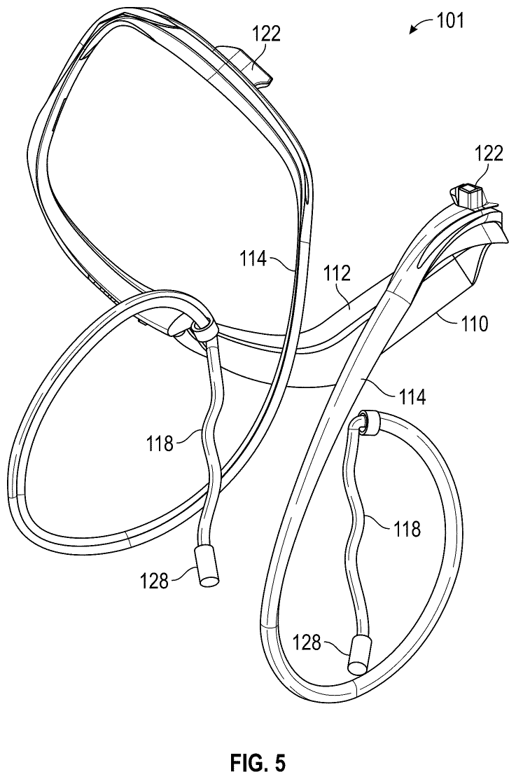

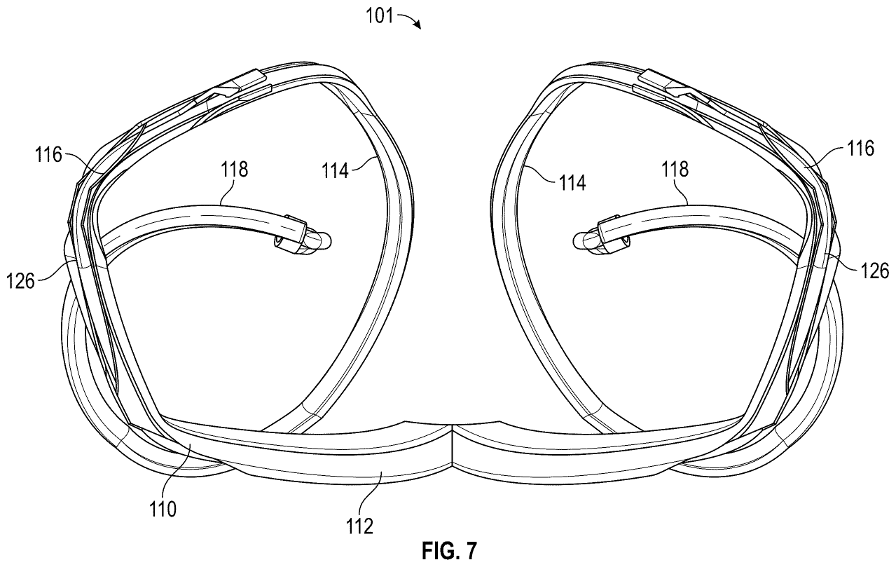

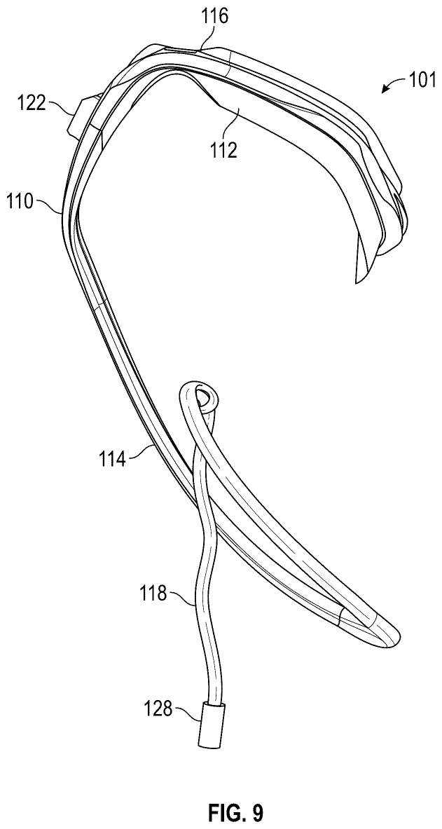

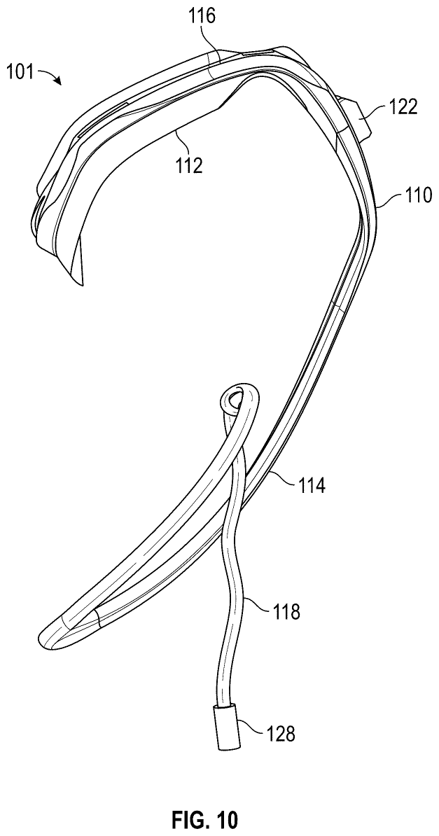

Referring to FIGS. 4-10, in another embodiment, gluteal manipulation device 101 comprises a single-body flexible harness 110 designed to be worn by a human user and a tensionable pulling element 118 that engages with the harness. The flexible harness 110 has a rear portion 112 configured to wrap around the user's waist or lower back and two downward extension portions 114 that extend toward the user's groin to anchor the structure.

In exemplary embodiments, the flexible harness 10, 110 wraps around the user's upper waist from the small of the back to the front sides, without forming a full belt, i.e., without fully closing around the waist of the user. The harness 10, 110 is an open design with no fasteners and no closed rings around bodyparts, eliminating all pelvic-restriction points and preserving unrestricted upper-leg and glute movement. Advantageously, this design provides claspless anatomical engagement, rhythmic response, unobstructed operation, and versatile use cases ranging from gluteal training to partnered play, aesthetic enhancement, and gynecological examinations as an alternative to a speculum.

The gluteal manipulation device 1, 101 is unisex and accommodates nearly all body types by coiling outward to fit various waist, hip, and thigh dimensions. However, different versions tailored for men and women with varying sizes and pulling element styles could be provided. The ergonomic contouring of the flexible harness 10, 110—free of poking or discomfort—and ability to function over light garments (lingerie, mesh bodysuits) or directly on skin broadens its application across fitness, therapy and aesthetic contexts.

The harness 10, 110 may be scaled for different body sizes or reinforced for heavier loads. For example, The flexible harness 10, 110 can be provided in multiple sizes and scaled to fit user sizes. The thickness, height, and width of the harness 10, 110 can vary to some degree to accommodate people of different heights, weights, and gender. For example, a width of about 300-310 mm and a height of about 210-220 fits a user having a clothing size of 10-12. The thickness of the harness 10, 110 also differs at the rear portion 12, 112 and downward extension portions 14, 114. For example, the thickest point of the harness 10, 110 is the rear portion 12, 112 where it is about 20-30 mm thick, and the thinnest point would be at the tips of the downward extension portions 14, 114 where it is about 3-8 mm thick. Similarly, the rear portion 12, 112 of the harness 10, 110 can range from about 30 mm to about 50 mm, and the height narrows to about 1-5 mm at the tips of the downward extension portions 14, 114.

The harness 10, 110 may be made of plastics, flexible thermoplastic elastomers, thermoplastic polyurethane, flexible resins, silicone rubbers, or overmolded TPU composites. In exemplary embodiments, the flexible harness 10, 110 is made from a durable, skin-safe photopolymer resin to protect the skin from rope friction and pressure while staying in place during movement. For example, the harness 10, 110 could be made of foam silicone or medical-grade silicone with a Shore hardness in the range of about A40-A100, optionally reinforced with hard plastics for durability and elasticity. The harness 10, 110 may incorporate embedded reinforcement, such as fibers, to adjust stiffness profiles. As discussed in more detail herein, the compliant material enables spring-like behavior, returning to a relaxed shape when tension is released.

In exemplary embodiments of the device 101, flexible harness 110 has a guide channel 116 running along its rear portion 112 and along the downward extension portions 114 to guide the tensionable pulling element 118. A guide channel or retention channel refers to any groove, track, or cutout formed in the device body to guide and secure the flexible pulling element in position during use. In this embodiment, the tensionable pulling element 118 sits in the guide channel 116. The guide channel 116 may be co-molded or inserted post-process depending on manufacturing method. The guide channel 116 may have retention lips 120 that capture the tensionable pulling element 118 and prevent it from slipping out during use. This retention feature keeps the tensionable pulling element 118 in place and within reach of the wearer at all times, unlike a free rope wrapped around the body, which would slide downward or fall to the ground when tension is released.

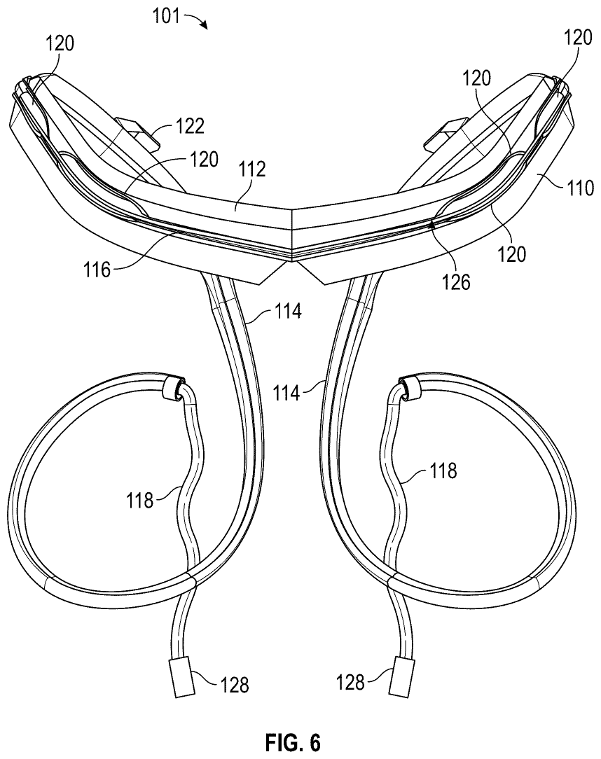

As best seen in FIGS. 6-8C, an exemplary guide channel 116 has a dual corkscrew or helical geometry 126, which, as discussed in more detail herein, enables the torque, spread, and oscillation that are the core purposes of the device 101. This is a dual helical path that wraps around the gluteal region, designed to guide pulling forces in both vertical and lateral directions to manipulate underlying tissue. This geometric configuration 126 begins at the user's lower back to bear the primary mechanical load and terminates at the overlap of the gluteal and hamstring muscles. The sculpted channeling 116 keeps the harness 110 tightly wrapped around the wearer's body. This is because the shape tightens around the hips under load, preventing the device from pulling off the body. In alternative embodiments, the corkscrew geometry may be replaced by S-shaped or spiral geometries.

The top of the dual corkscrew 126 begins at the wearer's lower back-an area of strength on the body-designating it to bear the brunt of the device's mechanical force when tensioned and to support the weight of the entire device in general. With the top of the dual corkscrew-like geometry 126 fixed to the wearer's lower back, the bottom tip of the helical shape experiences the most movement when tensioned. It is for that reason that the harness'bottom tip grips where the body's gluteus maximus overlaps the semitendinosus and biceps femoris long head. Targeting this zone advantageously generates the most pronounced and bouncy gluteal movement of the body with the least effort. Furthermore, the corkscrew shape 126 prevents the device 101 from pulling off the body when tensioned. In fact, because of its geometry, the device 101 tightens around the hips when tensioned, enhancing grip and stability. Additionally, when the corkscrew shape 126 tightens, it squeezes each glute upward and outward, spreading the rear end open with the pressure.

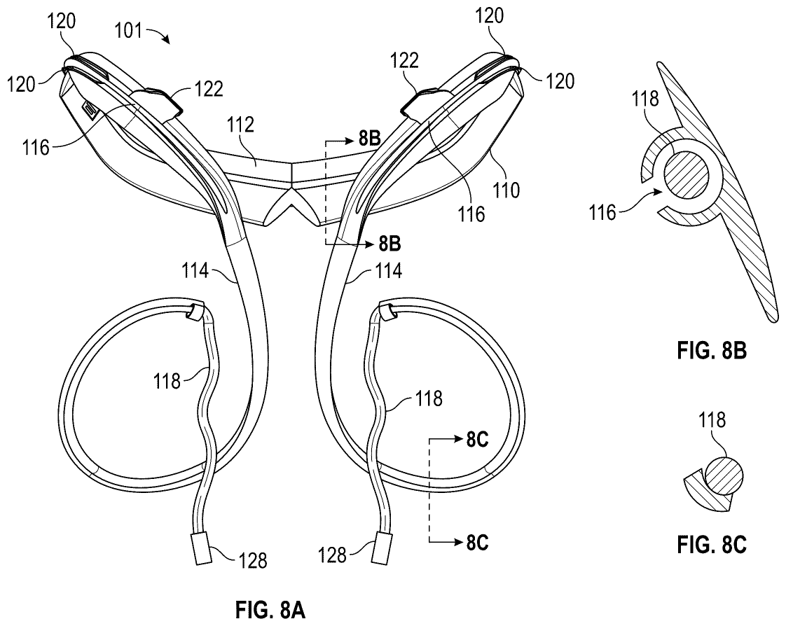

The dual corkscrew geometry 126 also squeezes each glute upward and outward under pressure, spreading the rear end open and enhancing anatomical engagement. Channels 16, 116 eliminate the need for hooks, knots, carabiners, and latches, reducing the parts count to two and enabling >500 lb tensile-strength performance via the tensionable pulling element 18, 118, while the harness merely guides and retains that force. As shown in FIGS. 8A-8C, channel geometry—varying in depth and arc thickness—controls flex and stiffness: deeper (A-A) where rigidity is needed, shallower (B-B) where the channel is designed to be less firm and bending is desired.

Flexible harness 110 also may have connected or integrally formed clips 122 for helping to keep the tensionable pulling element 118 in place when the device 101 is not in use. In exemplary embodiments, there is a clip 122 located on each side of the flexible harness 110 toward the front near where the user's hip bones would be when wearing the device 101.

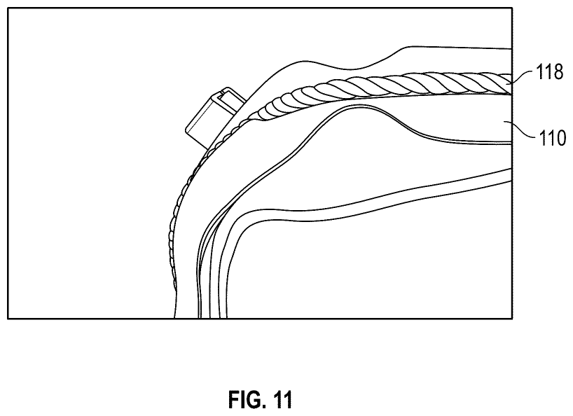

Turning to FIGS. 9-11, tensionable pulling element 18, 118 can be any kind of flexible rope, tube, or cord. It may be silicone-based for compatibility with clothing. In exemplary embodiments, tensionable pulling element 18, 118 is a silk rope providing desirable softness for comfort and friction properties for functionality. The diameter of the tensionable pulling element 18, 118 is about 5-10 mm. The tensionable pulling element 18, 118 may include multiple segments, elastic inserts, or integrated sensors for motion tracking, as well as handles 128 at the ends to ease grasping and holding onto the pulling element by the user. Embodiments may include alternate materials for the tensionable pulling element 18, 118 (silicone tubing, bungee cord) and decorative accents (tassels, light-reflective finishes).

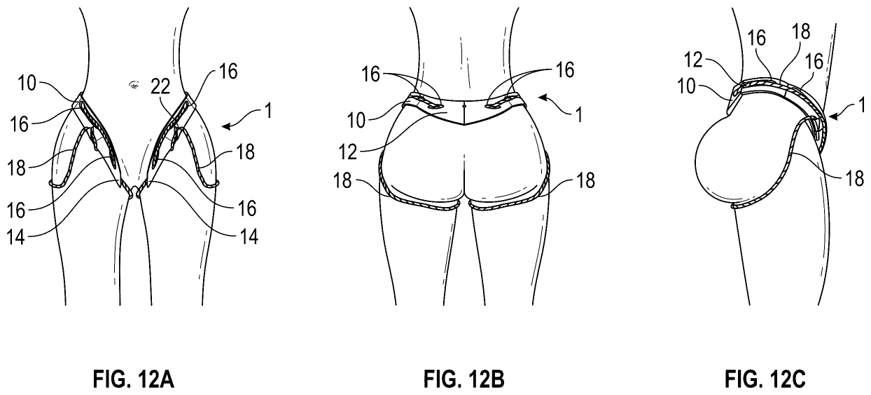

With gluteal manipulation device 1, tensionable pulling element 18 is threaded through spaced apart channels 16 in the harness 10, exits at the front, and wraps under the gluteal muscles through the user's legs, as illustrated in FIGS. 12A, 12B, and 12C. The ends of the tensionable pulling element 18 rest on clips 22 toward the front of the harness for easy access by the user. In device 101, tensionable pulling element 118 sits in guide channel 116 in the harness 110, exits at the front, and wraps under the gluteal muscles through the user's legs.

It should be noted that gluteal manipulation device 101 can function with the flexible harness 110 alone, that is, without the need for a separate tensionable pulling element 118. More particularly, the flexible harness 110 itself can serve as a pulling element if the user grabs and pulls the ends or tips of the flexible harness 110, either at the end of each downward extension portion 114 or where the rear portion 112 meets each downward extension portion 114. Thus, in effect, the pulling element could be the flexible harness 110 itself because the shape of the gluteal manipulation device 101 and its placement on the body are key to its functionality. However, the separate tensionable pulling element 118 enables the device 101 to function more powerfully and more easily.

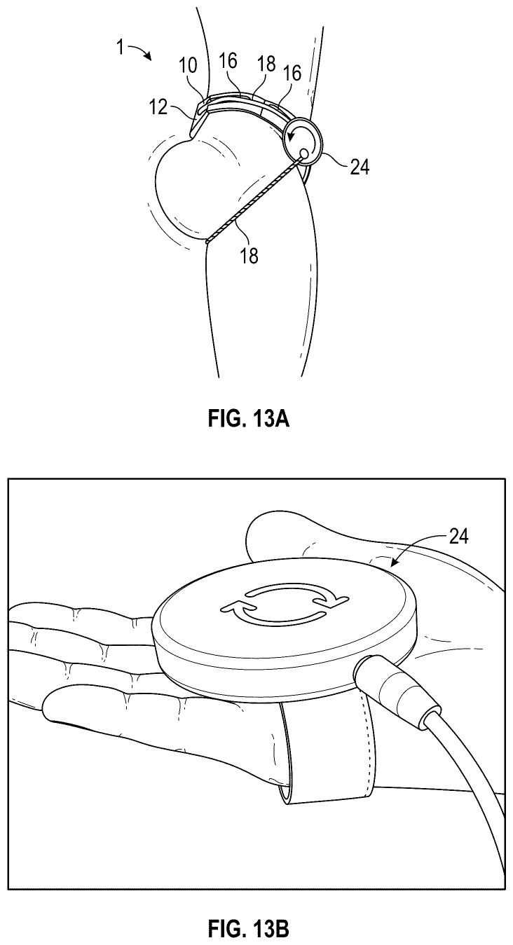

Exemplary embodiments of the gluteal manipulation device 1, 101 provide motorized use instead of the user manually pulling the tensionable pulling element 18, 118. As best seen in FIG. 13A, one or more actuators 24 can be incorporated into the flexible harness 10, 110 and connected to the tensionable pulling element 18, 118. Actuators 24 may be located toward the front of the harness 10, 110 on each side and in one embodiment they replace clips 22. Alternatively, actuator 24 could be hand-held or worn in the user's palm, as illustrated in FIG. 13B. The actuators 24 may be capstan actuators. They may be powered by a battery and a motor controller mounted on the harness 10, 110. Actuators 24 pull the tensionable pulling element 18, 118 automatically and enable programmable and remote-controlled operation.

In exemplary embodiments, an actuator-driven version of the device 1, 101 functions through two compact, puck-shaped motor housings, each worn in the user's palm and secured with a strap that wraps around the back of the hand. Each housing contains a miniature rotary actuator and a Needle-Bar Slot Cam mechanism that repeatedly pulls one of the two ends of the tensionable pulling element 18, 118 extending from the harness 10, 110. When both actuators 24 pull in synchronized or alternating motion, the resulting tension induces rhythmic movement of the wearer's hips and gluteal region. Exemplary actuators 24 are battery powered and communicate wirelessly (e.g., via Bluetooth) to maintain synchronization.

As an alternative to rope, the tensionable pulling element 18, 118 could be a flexible cable incorporating internal wiring to transmit power and data, enabling embedded sensors and decorative or functional lighting. The actuators 24 can also track glute movement via the sensors and integrate with mobile apps or internet platforms for advanced functionalities. For example, sensors can capture motion data to dynamically adjust the movement pattern, synchronize the actuation to music beats, or respond to commands from a mobile application that provides performance tracking, dance-pattern selection, or remote operation by another user.

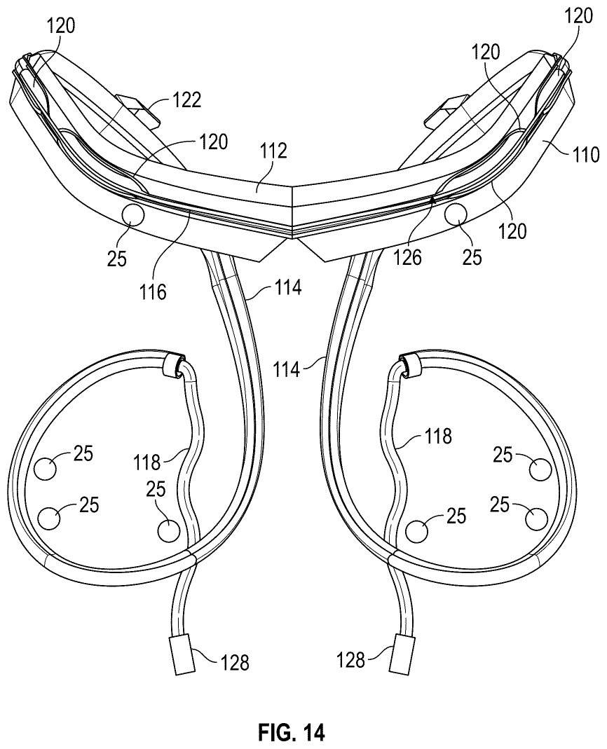

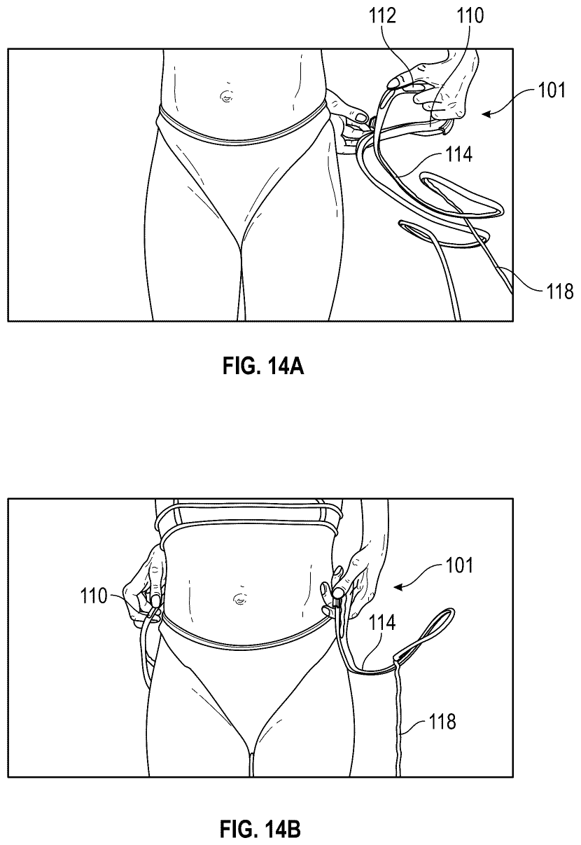

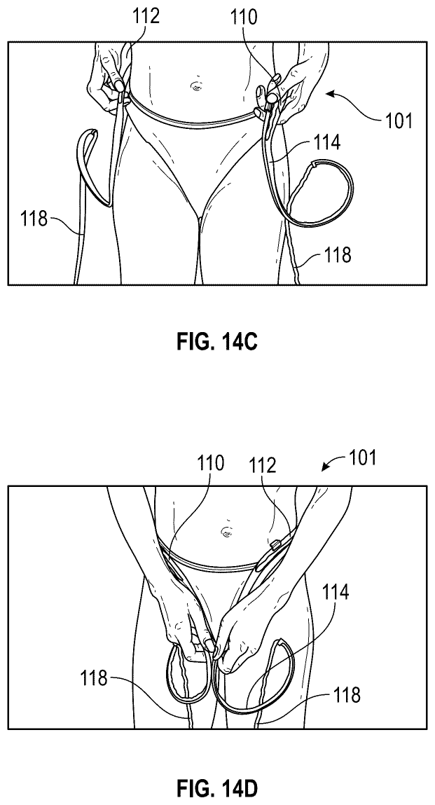

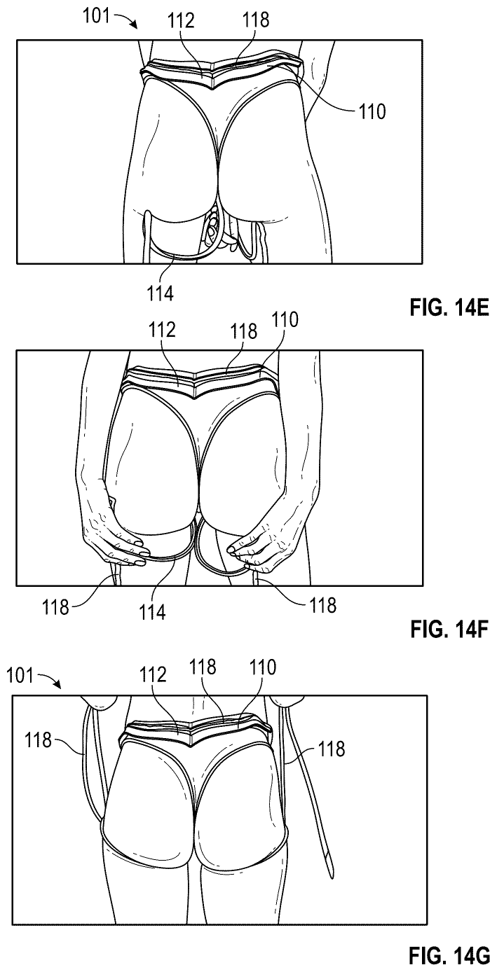

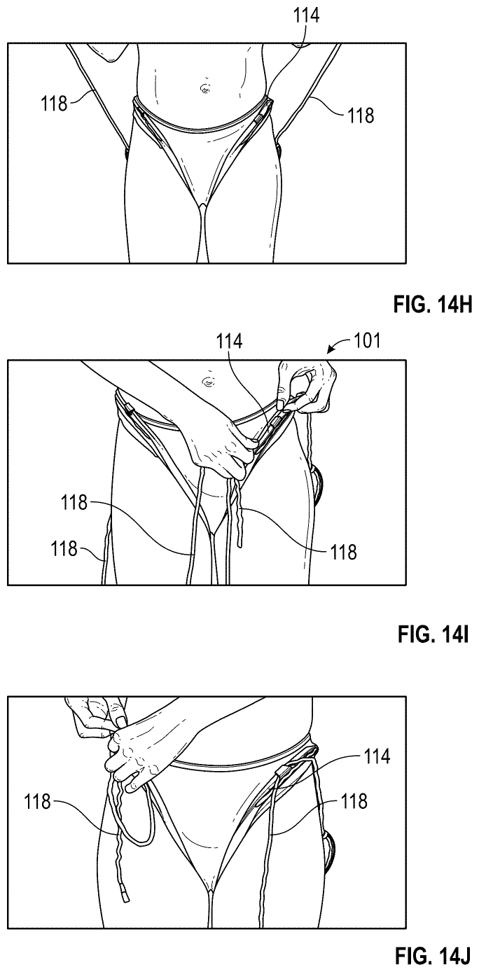

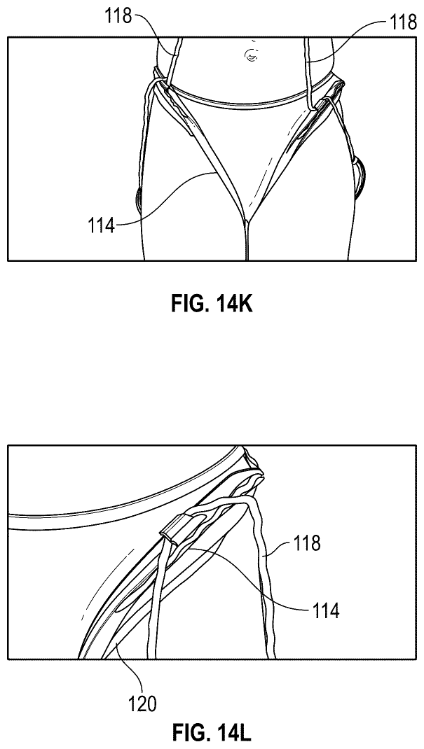

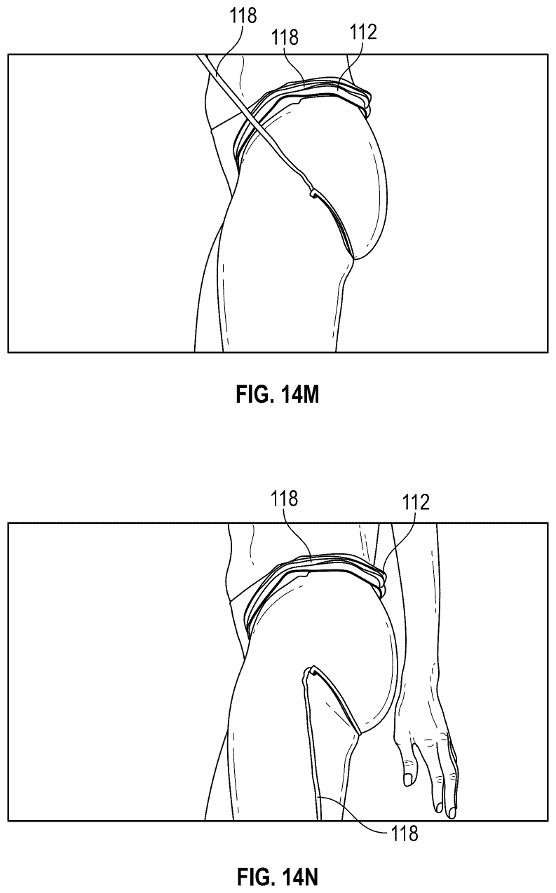

Exemplary sensor locations 25 are shown in FIG. 14, where the locations (inside the device 101) are indicated with small circles. They are located within the cable 118 that is strung through the guide channels 116 of the harness 110. Each sensor is a position, acceleration, etc. type of sensor typically just a few millimeters square. Exemplary sensors include, but are not limited to, accelerometers, gyroscopes, and IMUs (Inertial Measurement Units) that are used in smartphones, smartwatches, and other compact electronics.

In operation, the user puts on the gluteal manipulation device 1, 101 by wrapping the flexible harness 10, 110 around the back of their waist and routes the end of each downward extension portion 14, 114 and the tensionable pulling element 18, 118 under the groin and out around the lower edge of the glutes. This process is illustrated in FIGS. 14A-14N. For gluteal manipulation device 1, the user threads the tensionable pulling element 18 through the spaced apart channels 16 in the harness 10 so the tensionable pulling element 18 exits at the front, and the user wraps the ends of the pulling element under the gluteal muscles through the user's legs. The user arranges the ends of the tensionable pulling element 18 so they rest on clips 22. For device 101, the user reaches around the back and pulls the tensionable pulling element 118 in the guide channel 116 in the harness 110 under the groin area.

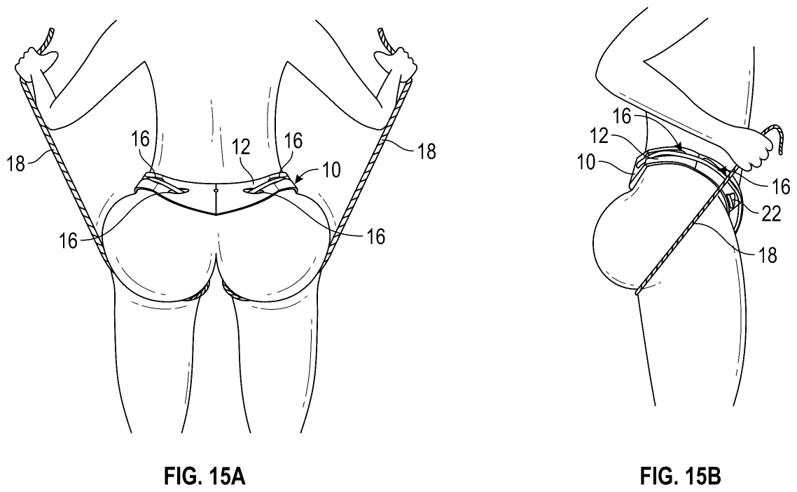

Tension can be applied manually or by using actuators 24. For manual operation, as shown in FIGS. 15A and 15B, the user grasps opposite ends of tensionable pulling element 18 and pulls both ends forward and/or upward, causing the tensionable pulling element to scoop the gluteal muscles for controlled movement. As the wearer pulls on both ends of the tensionable pulling element 18, the harness 10 tightens around the hips and under the glutes. Releasing and re-tensioning the tensionable pulling element 18 causes the harness to oscillate and manipulate the glutes, with the tensionable pulling element remaining in place-never slipping down or falling away.

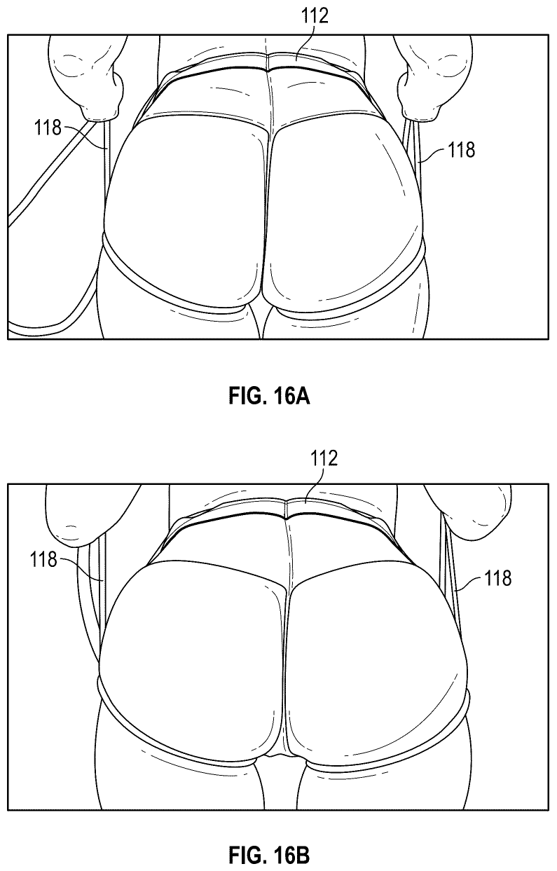

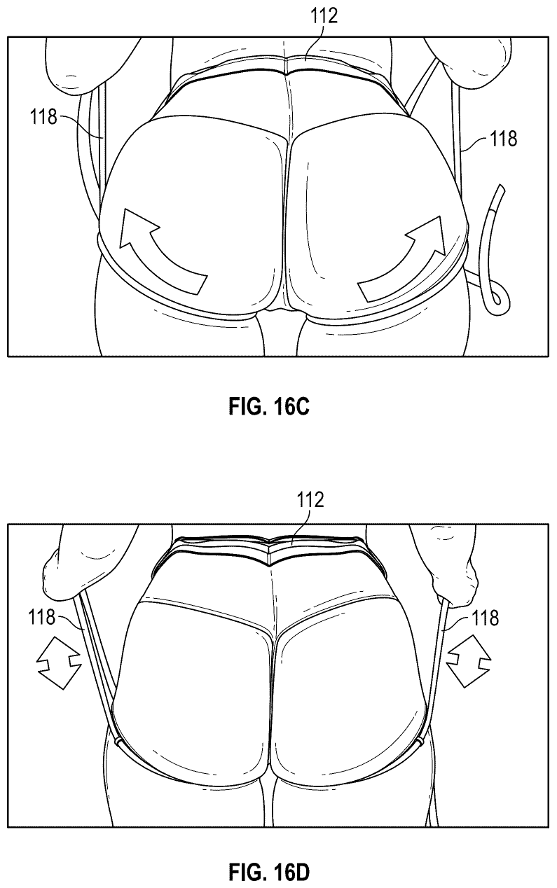

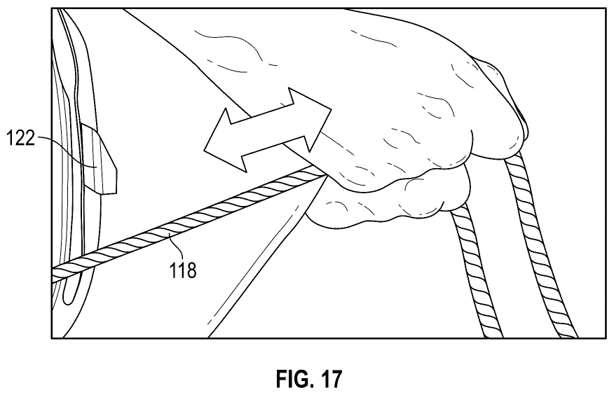

More particularly, referring to FIGS. 16A-16D and 17 where arrows and diamonds indicate force direction, when the tensionable pulling element 118 is tensioned, the harness 110 dynamically lifts, spreads, and oscillates the wearer's glutes using the dual corkscrew-like helical geometry. This corkscrew pathway, combined with body tension and friction, causes the soft tissue around the hip bone, pelvis, and femur to twist upward and outward. This self-tightening helical action enables dynamic manipulation without added fasteners and supports rhythmic motion through anatomical engagement of key muscle groups.

The corkscrew configuration begins at the user's lower back to bear the primary mechanical load and terminates at the glute-ham overlap to generate maximal, dynamic posterior oscillation. Posterior oscillation refers to a dynamic, cyclical displacement of the gluteal region resulting from alternating tension and release applied to the pulling elements, producing rhythmic upward, outward, and return motion of the glutes. This manipulation of the gluteal muscles is enhanced by the compliant material of the harness 10, 110 which enables spring-like behavior, returning to a relaxed shape when tension is released.

Alternatively, the user can turn on and operate actuators 24 so they pull, release, and re-tension the tensionable pulling element 18, 118. The pulling, releasing, and re-tensioning motions advantageously provide exercise for the arms and glutes simultaneously. The user may perform these motions while dancing, exercising, or during intimate activity. When finished using the gluteal manipulation device 1, 101, the user removes both ends of the tensionable pulling element 18, 118 and each downward extension portion 14, 114 from under the groin and unwraps the flexible harness 10, 110 from around the back of their waist. The device 1, 101 is thus removed from the user's body. When not worn, gluteal manipulation device 101 can be collapsed into a planar configuration for compact storage. More particularly, the device 101 coils flat for convenient storage in drawers, pouches, or bags, and may be rinsed or wiped clean between uses.

Also, as discussed above, the user can operate the gluteal manipulation device 101 with the flexible harness 110 alone without the need for a separate tensionable pulling element 118. In such operation, the flexible harness 110 itself serves as a pulling element. The user grabs and pulls the tips of the flexible harness 110, either at the end of each downward extension portion 114 or where the rear portion 112 meets each downward extension portion 114. By pulling and releasing in this way, the device 101 tensions, releases, and re-tensions, oscillating the gluteal region.

Exemplary embodiments can be used for many different applications. The gluteal manipulation device 1, 101 can be used for entertainment, including dance routines, erotic performances, or visual enhancements with lighting or vibration. Exemplary embodiments could include enhanced motorized features, such as synchronization with music or other devices. In performance or fashion settings, the harness 10, 110 serves as both a structural device and visual accessory, appealing for artistic and self-expression uses.

Another application is fitness and exercise routines, such as arm and glute workouts with varying resistance. The wearer could use the device 1, 101 as shapewear, including passive wear to accentuate the waist and glute-to-hamstring separation. Non-motorized versions of the device with a thinner harness could be provided for such shapewear uses. The device 1, 101 also allows for novelty uses and simply having fun such as for party gags, twerk competitions, and interactive live-streaming applications.

Various kinds of medical and therapeutic use are possible. One example is gluteal muscle massage and assisted movement. The gluteal manipulation device 1, 101 also may assist in lymphatic drainage along the glute-hamstring crease by providing rhythmic compression and friction. Over time, this may improve circulation and muscle definition. As a fascia-therapy tool, the device 1, 101 encourages myofascial stimulation and a stronger mind-muscle connection, enhancing conscious glute control. Applications can include support for medical rehabilitation (e.g., post-op glute activation), athletic training (e.g., glute activation warmups), and AR/VR integration (e.g., in entertainment applications, the harness may be paired with motion-tracking sensors). The device also could be used by medical practitioners for gynecological examinations as an alternative to a speculum.

Thus, it is seen that devices and methods of gluteal manipulation are provided. It should be understood that any of the foregoing configurations and specialized components may be interchangeably used with any of the systems of the preceding embodiments. Although illustrative embodiments are described hereinabove, it will be evident to one skilled in the art that various changes and modifications may be made therein without departing from the disclosure. It is intended in the appended claims to cover all such changes and modifications that fall within the true spirit and scope of the disclosure.

While the disclosed devices and methods have been described in terms of what are presently considered to be the most practical exemplary embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A gluteal manipulation device, comprising:
a flexible harness configured to be worn by a user, the flexible harness defining at least one guide channel and including a rear portion configured to wrap around the user's waist and two downward extension portions configured to sit adjacent to the groin of the user; and
a tensionable pulling element having two ends, the tensionable pulling element at least partially running through the at least one guide channel such that the two ends extend from the two downward extension portions;
wherein the at least one guide channel runs along the flexible harness and the tensionable pulling element sits in the guide channel;
wherein the at least one guide channel has a dual corkscrew geometry; and
wherein when the two ends of the tensionable pulling element are pulled, the flexible harness moves the gluteal muscles of the user.

2. The gluteal manipulation device of claim 1 wherein the user pulls the two ends of the tensionable pulling element forward or upward.

3. The gluteal manipulation device of claim 1 further comprising at least one actuator incorporated into the device;
wherein the at least one actuator pulls the two ends of the tensionable pulling element.

4. The gluteal manipulation device of claim 1 wherein the at least one channel comprises a plurality of channels, and the tensionable pulling element is threaded through the plurality of channels.

5-6. (canceled)

7. The gluteal manipulation device of claim 1 wherein the guide channel has a geometry that varies in depth and arc thickness, thereby varying flex and stiffness.

8. The gluteal manipulation device of claim 1 further comprising retention lips running along the guide channel;
wherein the tensionable pulling element is maintained in the guide channel by the retention lips.

9. The gluteal manipulation device of claim 1 wherein the flexible harness provides anatomical engagement, wrapping around the waist of the user and staying in place without fully closing around the waist of the user.

10. The gluteal manipulation device of claim 1 wherein the flexible harness provides anatomical engagement, wrapping around the waist of the user and staying in place without any fasteners.

11. The gluteal manipulation device of claim 1 wherein the tensionable pulling element is a rope, cord, or flexible tube.

12. The gluteal manipulation device of claim 1 wherein the flexible harness returns to a relaxed shape when the user releases tension on the tensionable pulling element.

13. (canceled)

14. The gluteal manipulation device of claim 1 wherein the rear portion of the flexible harness wraps around the user's lower back or waist and the two downward extension portions terminate at or near where the gluteal muscles and hamstring muscle overlap.

15. The gluteal manipulation device of claim 1 wherein the device has a tensile strength of about 500 pounds per square inch.

16. A gluteal manipulation device, comprising:
a flexible harness configured to be worn by a user, the flexible harness defining at least one guide channel and including a rear portion configured to wrap around the user's waist and two downward extension portions configured to sit adjacent to the groin of the user;
a tensionable pulling element having two ends, the tensionable pulling element at least partially running through the at least one guide channel such that the two ends extend from the two downward extension portions;
wherein the at least one guide channel runs along the flexible harness and the tensionable pulling element sits in the guide channel;
wherein the at least one guide channel has an S-shaped or spiral geometry; and
wherein when the ends of the two downward extension portions of the flexible harness are pulled forward or upward, the flexible harness moves the gluteal muscles of the user.

17. A method of manipulating gluteal muscles, comprising:
wrapping a rear portion of a flexible harness around the back of the waist, the flexible harness defining at least one guide channel;
routing two downward extension portions under the groin;
applying tension to a tensionable pulling element running through at least one guide channel defined in the flexible harness by pulling two ends of the tensionable pulling element forward or upward to cause the flexible harness to move the gluteal muscles, the tensionable pulling element having two ends, the tensionable pulling element at least partially running through the at least one guide channel such that the two ends extend from the two downward extension portions;
wherein the at least one guide channel runs along the flexible harness and the tensionable pulling element sits in the guide channel;
wherein the at least one guide channel has a dual corkscrew geometry.

18. The method of claim 17 further comprising releasing the tension on the tensionable pulling element to cause the flexible harness to return to a relaxed shape and re-tensioning the tensionable pulling element to cause the flexible harness to oscillate the gluteal muscles.

19. The method of claim 18 wherein the applying the tension, releasing the tension, and re-tensioning the tensionable pulling element are performed while dancing, exercising, or during intimate activity.

20. The method of claim 17 wherein applying tension to the tensionable pulling element comprises activating an actuator.
